(19) United States
(12) Patent Application Publication
(10) Pub. No.: US 2022/0072652 A1
(43) Pub. Date: Mar. 10, 2022

(54) BUS BAR AND MANUFACTURING METHOD THEREOF

(71) Applicants: HYUNDAI MOTOR COMPANY, Seoul (KR); KIA MOTORS CORPORATION, Seoul (KR); A.F.W. CO., LTD., Waegwan-eup (KR)

(72) Inventors: Byong Soo Kim, Uiwang-si (KR); Jae Sun Lim, Seoul (KR); Jong Duk Seo, Daegu (KR); Ki Young Kim, Daegu (KR)

(73) Assignees: HYUNDAI MOTOR COMPANY, Seoul (KR); KIA MOTORS CORPORATION, Seoul (KR); A.F.W. CO., LTD., Waegwan-eup (KR)

(21) Appl. No.: 17/200,254

(22) Filed: Mar. 12, 2021

(30) Foreign Application Priority Data
Sep. 10, 2020 (KR) 10-2020-0115883

(51) Int. Cl. B23K 20/12; H01R 43/02; H01B 1/02; H01R 4/02

(52) U.S. Cl. CPC B23K 20/129; H01R 43/0214; B23K 2101/38; H01B 1/026; H01R 4/021; H01B 1/023

(57) ABSTRACT

A bus bar and a method of manufacturing the same may include a first metal portion made of a first metal material; and a second metal portion made of a second metal material different than the first metal portion. The first metal portion and the second metal portion are coupled by a rotation friction welding (RFW).

### CROSS-REFERENCE TO RELATED APPLICATION

This application claims priority to and the benefit of Korean Patent Application No. 10-2020-0115883 filed in the Korean Intellectual Property Office on Sep. 10, 2020, the entire contents of which are incorporated herein by reference.

### BACKGROUND

### (a) Field of the Disclosure

The present disclosure relates a bus bar and a method of manufacturing the same. More particularly, the present disclosure relates to a bus bar and a method of manufacturing the same made by a rotation friction welding (RFW) using different materials.

### (b) Description of the Related Art

In recent years, environment-friendly vehicles, such as electric vehicles or hybrid vehicles, are driven by a drive motor operated by electrical energy.

Since such vehicles are very heavy, it is necessary to increase the output of the drive motor to accelerate at high speed.

The output of the drive motor is determined by the magnitude of the applied voltage. The output of the drive motor is controlled as the DC current output from the battery is converted into AC current by an inverter. The inverter is connected to the drive motor by a connector equipped with a cable.

A bus bar, which is a conductor, is provided to supply the AC current converted by the inverter to the drive motor. The inverter is connected to the connector through the bus bar to supply the AC current to the drive motor. The bus bar replaces wires and can supply large electrical capacity to the drive motor from the battery or a generator.

Since conventional bus bar is formed in a bar shape and formed of the same material (e.g., copper), there is a problem that the entire weight and manufacturing cost are increased.

The above information disclosed in this Background section is only to enhance understanding of the background of the disclosure. Therefore, the Background section may contain information that does not form the prior art that is already known in this country to a person of ordinary skill in the art.

### SUMMARY

An embodiment of the present disclosure provides a bus bar and a method of manufacturing the same that can reduce the entire weight and manufacturing cost of the bus bar.

Further, the present disclosure provides a bus bar and a method of manufacturing a bus bar that is robust to external impact or vibration.

A bus bar according to an embodiment of the present disclosure may include a first metal portion made of a first metal material and a second metal portion made of a second metal material different to the first metal portion. The first metal portion and the second metal portion are coupled by a rotation friction welding (RFW).

The first metal material may be aluminum.

The second metal material may be copper.

Silver may be plated on the surface of the second metal portion.

A stepped portion may be formed in the second metal portion. The stepped portion may be formed by a first body and a second body. A diameter of the first body may be the same as the diameter of the first metal portion and a diameter of the second body may be smaller than the diameter of the first body.

Silver may be plated on only the second metal portion except for the stepped portion.

A plurality of grooves may be formed on the stepped portion along a circumferential direction.

The grooves may be formed as a plane or planar surface on the stepped portion parallel to a central axis of the first metal portion.

A bolt fastening hole may be formed on a bottom of the first metal portion.

A method of manufacturing a bus bar according to another embodiment of the present disclosure may include: processing a first metal portion of a first metal material; processing a second metal portion made of different material from the first metal material; plating the second metal portion with silver; and welding the first metal portion and the second metal portion by a rotation friction welding (RFW).

The welding may include: mounting one of the first metal portion and the second metal portion in a clamp chuck; mounting the other of first metal portion and the second metal portion in a rotation chuck; rotating the metal portion mounted in the rotation chuck; contacting the metal portion mounted in the rotation chuck to the metal portion mounted in the clamp portion; stopping the rotation chuck; and pressing the metal portion of the rotation chuck to the metal portion of the clamp chuck.

The method may further include removing a burr formed by the rotation friction welding.

The method may further include processing a stepped portion in the second metal portion.

The stepped portion may be formed by a first body and a second body. A diameter of the first body may be same as the diameter of the first metal portion. A diameter of the second body may be smaller than the diameter of the first body.

The method may further include processing a plurality of grooves in the second metal portion.

The plurality of grooves may be parallel to a central axis of the bus bar.

The method may further include processing a bolt fastening hole in a bottom of the first metal body.

According to an embodiment of the present disclosure, since two metal portions made of different materials are conjoined by a rotation friction welding, it is possible to reduce the entire weight and manufacturing cost of a bus bar.

Further, plating portions of the bus bar is minimized, thereby minimizing manufacturing cost and realizing an environment-friendly manufacturing method.

### BRIEF DESCRIPTION OF THE DRAWINGS

The drawings are provided for reference to explain an illustrative embodiment of the present disclosure, and the technical spirit of the present disclosure should not be interpreted to be limited to the accompanying drawings.

FIG. 1 is a perspective view illustrating a bus bar according to an embodiment of the present disclosure.

FIG. 2 is a flowchart illustrating a manufacturing method of the bus bar according to an embodiment of the present disclosure.

FIG. 3 is a diagram illustrating a manufacturing method of the bus bar according to an embodiment of the present disclosure.

FIG. 4 is a flowchart illustrating a process of a rotary friction welding of the bus bar according to an embodiment of the present disclosure.

FIG. 5 is a diagram illustrating a process of a rotary friction welding of the bus bar according to an embodiment of the present disclosure.

FIG. 6 is a perspective view illustrating a state where the bus bar is mounted according to an embodiment of the present disclosure.

FIG. 7 is a cross-sectional view illustrating a state where the bus bar is mounted according to an embodiment of the present disclosure.

### DETAILED DESCRIPTION OF THE EMBODIMENTS

The present disclosure is described more fully hereinafter with reference to the accompanying drawings, in which embodiments of the disclosure are shown. As those of ordinary skill in the art should realize, the described embodiments may be modified in various different ways, all without departing from the spirit or scope of the present disclosure.

To clearly describe the present disclosure, parts that are irrelevant to the description are omitted. Like numerals refer to like or similar constituent elements throughout the specification.

The size and the thickness of each component illustrated in the drawings are arbitrarily illustrated in the drawings for better understanding and ease of description. However, the present disclosure is not limited to the illustrations. In the drawings, the thicknesses of various portions and regions are enlarged for clarity.

Hereinafter, a bus bar according to an embodiment of the present disclosure is described in detail with reference to the accompanying drawings.

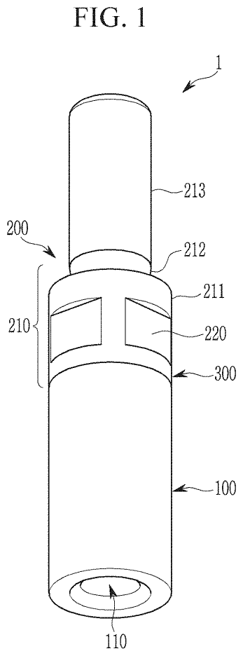

FIG. 1 is a perspective view illustrating a bus bar according to an embodiment of the present disclosure.

As shown in FIG. 1, a bus bar according to an embodiment of the present disclosure may include a first metal portion 100 and a second metal portion 200 made of different materials.

The first metal portion 100 is formed as a cylinder shape and the first metal portion 100 may be made of aluminum (AI) material.

The second metal portion 200 may be coaxially positioned with the first metal portion 100, may have a different diameter than the first metal portion 100, may be formed as a cylinder shape, and may be made of a copper (Cu) material. For example, the second metal portion 200 may include a first body 201 formed as a cylinder shape and a second body 202 having a smaller diameter than that of the first body. The diameter of the second body 202 may be the same as the diameter of the first metal portion 100.

Silver (Ag) may be plated on the surface of the second metal portion 200.

A stepped portion 210 may be formed in the second metal portion 200. The stepped portion 210 may be formed by the first body 201 and the second body 202. The stepped portion 210 may be processed by a CNC lathe (computer numerically controlled lathe).

Only a portion 213 of the second metal portion 200, except for the stepped portion 210, may be plated with silver.

A plurality of grooves 220 may be formed on an exterior circumference of the stepped portion 210 (e.g., an exterior circumference of the first body 211 of the stepped portion 210).

The plurality of grooves 220 may be formed as a plane or a planar surface on the exterior circumference of the stepped portion and may be parallel to a central axis of the first metal portion 100 (or the second metal portion 200). The plurality of grooves 220 may be disposed or spaced apart equal distance along a circumferential direction.

A bolt fastening hole 110 may be formed on a bottom of the first metal portion 100 to insert a bolt.

Hereinafter, a manufacturing method of the bus bar according to an embodiment of the present disclosure is described in detail with reference to the accompanying drawings.

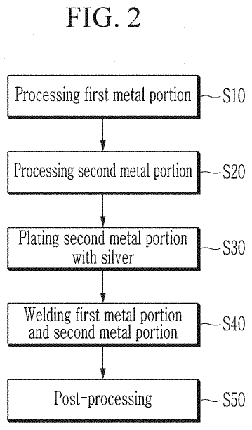

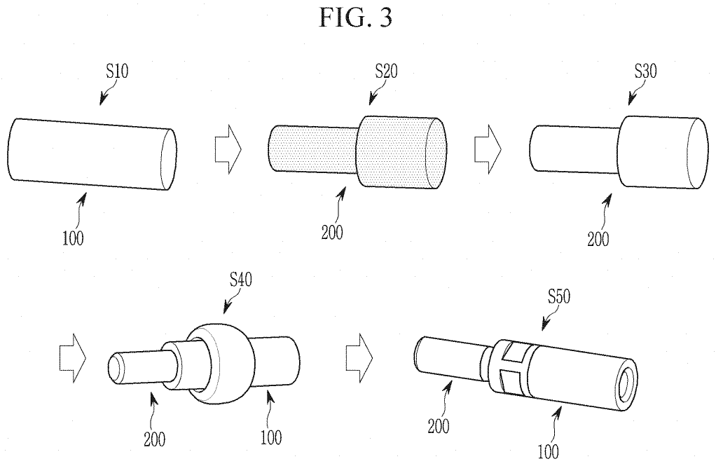

FIG. 2 is a flowchart illustrating a manufacturing method of the bus bar according to an embodiment of the present disclosure. FIG. 3 is a diagram illustrating a manufacturing method of the bus bar according to an embodiment of the present disclosure.

As shown in FIG. 2 and FIG. 3, the first metal portion 100 formed as a cylinder shape is processed (or formed) by a press cutting machine at step S10. As described above, the first metal portion 100 is made of aluminum (AI) material.

The second metal portion 200 having a different diameter than the first metal portion 100 is processed (or formed) by a CNC lathe at step S20. As described above, the second metal portion 200 is made of copper (Cu) material.

The second metal portion 200 is plated with silver (Ag) by an electroplater at step S30. At this time, the second metal portion 200 is immersed in an electroplating tank where an electrolyte solution is stored. The silver material is immersed in the electroplating tank spaced apart from the first metal portion 200 by a predetermined distance.

A negative electrode(−) is electrically connected to the second metal portion 200, and a positive electrode(+) is electrically connected to the silver (Ag) material. At this time, when a current is applied to the positive electrode and the negative electrode, a metal ion of the silver material is plated to the surface of the second metal portion 200 by electrolysis. Silver may be plated on the surface of the second metal portion 200 by a predetermined thickness through this electroplating process.

The first metal portion 100 and the second metal portion 200 are welded by a friction welding machine at step S40.

Herein, a process of welding the first metal portion 100 and the second metal portion 200 by a rotation friction welding is described in detail.

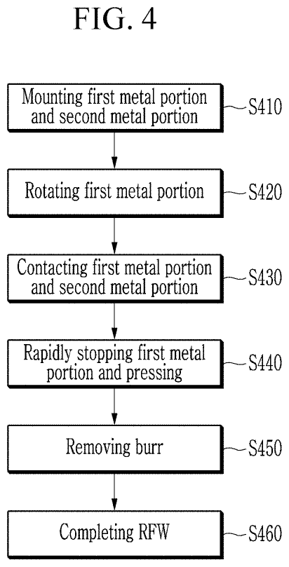

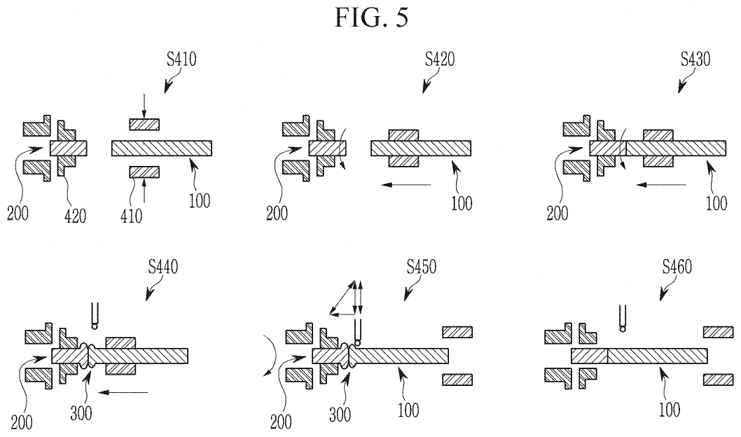

FIG. 4 is a flowchart illustrating a process of rotary friction welding of the bus bar according to an embodiment of the present disclosure. FIG. 5 is a diagram illustrating a process of rotary friction welding of the bus bar according to an embodiment of the present disclosure.

As shown in FIG. 4 and FIG. 5, the first metal portion 100 is mounted in a spindle chuck 410 (rotation chuck) of the friction welding machine. The second metal portion 200 is mounted in a clamp chuck 420 of the friction welding machine at step S410.

The first metal portion 100 is rotated at a predetermined speed (e.g., 1,600-2,200 RPM) by rotating the rotation chuck 410 at step S420.

By moving the rotation chuck 410 to the clamp chuck 420, the first metal portion 100 mounted in the rotation chuck 410 and the second metal portion 200 mounted in the clamp chuck 420 come in contact with each other at step S430.

When the first metal portion 100 and the second metal portion 200 contact with each other as the first metal portion 100 is rotated at a high speed, the contacting surfaces between the first metal portion 100 and the second metal portion 200 are melted by frictional heat.

When the friction heat generated in the contacting surfaces between the first metal portion 100 and the second metal portion 200 reaches a predetermined temperature (e.g., melting point of the first metal portion 100 and the second metal portion 200), the spindle chuck is rapidly stopped. Then, the first metal portion 100 mounted in the spindle chuck is pressed to the second metal portion 200 mounted in the clamp chuck. Thus, the first metal portion 100 and the second metal portion 200 are conjoined at step S440.

For example, 7 to 20 tons of pressure may be applied to the second metal portion 200 while the first metal portion 100 moves toward the second metal portion 200 by 5 mm.

Thereafter, a welding portion 300 (e.g., a burr) formed by the friction welding is processed (or removed) by the CNC lathe at step S450. The rotation friction welding process is thus completed at step S460.

Referring back to FIG. 2 and FIG. 3, the plurality of grooves 220 and the bolt fastening hole 110 are processed (or formed) by post-processing at step S50.

For example, the plurality of grooves 220 and the bolt fastening hole 110 are processed by the CNC lathe.

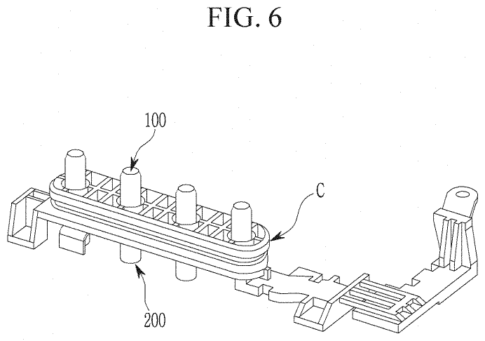

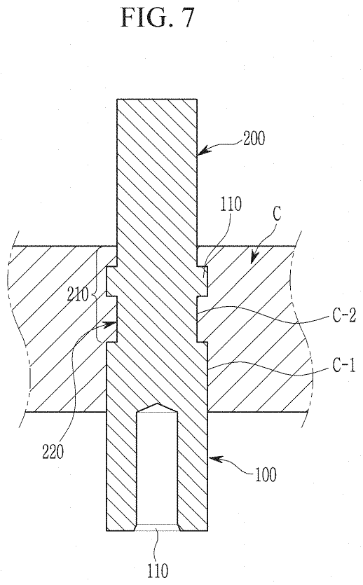

FIG. 6 is a perspective view illustrating a state where the bus bar is mounted according to an embodiment of the present disclosure. FIG. 7 is a cross-sectional view illustrating a state where the bus bar is mounted according to an embodiment of the present disclosure.

As shown in FIG. 6 and FIG. 7, the bus bar according to an embodiment of the present disclosure may be mounted in a connector C.

The connector C connects an inverter and a drive motor. A coupling hole C-1 may be formed in the connector corresponding to the bus bar according to an embodiment of the present disclosure.

A coupling protrusion C-2 may be protruded in an interior circumference of the coupling hole C-1. The coupling protrusion C-2 corresponds to the grooves 220 of the second metal portion 200 and thus may include multiple protrusions corresponding to the number of grooves 220.

When the bus bar is engaged to the coupling hole C-1 of the connector C, the coupling protrusion C-2 is inserted into the grooves 220 of the second metal portion 200. Thus, it is possible to prevent the bus bar from being rotated.

Through this, even if an additional coupling means is not used, the bus bar is easily coupled to the connector and it is possible to prevent the bus bar from being rotated or separated from the connector. In addition, the bus bar and the connector may be firmly connected to one another even if external vibration or impact is generated.

Further, since the first metal portion 100 made of aluminum material and the second metal portion 200 made of copper material are coupled by the rotation friction welding process, the entire weight of the bus bar is reduced by about 34% and the usage amount of copper is reduced by about half compared to a case where the first metal portion 100 and the second metal portion 200 are made of copper. Further, the usage amount of silver and the manufacturing coating are reduced compared to a case where the bus bar is entirely plated with silver.

Also, only the contacting portions between the first metal portion and the second metal portion are plated with silver, thereby minimizing the plated portions and realizing an environment-friendly manufacturing method.

Furthermore, since the first metal portion 100 and the second metal portion 200 are welded by the rotation friction welding process, the bus bar is firmly coupled and has high strength.

While this disclosure has been described in connection with what are presently considered to be practical embodiments, it should be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

1: bus bar
100: first metal portion
110: bolt fastening hole
200: second metal portion
210: stepped portion
220: groove
300: welding portion

What is claimed is:

1. A bus bar comprising:
a first metal portion made of a first metal material; and
a second metal portion made of a second metal material different than the first metal portion,
wherein the first metal portion and the second metal portion are coupled by a rotation friction welding (RFW).

2. The bus bar of claim 1, wherein:
the first metal material is aluminum.

3. The bus bar of claim 1, wherein:
the second metal material is copper.

4. The bus bar of claim 1, wherein:
silver is plated on a surface of the second metal portion.

5. The bus bar of claim 4, wherein:
a stepped portion is formed in the second metal portion,
the stepped portion is formed by a first body and a second body,
a diameter of the first body is the same as the diameter of the first metal portion, and
a diameter of the second body is smaller than the diameter of the first body.

6. The bus bar of claim 5, wherein:
silver is plated on only the second metal portion, except for the stepped portion.

7. The bus bar of claim 5, wherein:
a plurality of grooves is formed on the stepped portion along a circumferential direction.

8. The bus bar of claim 7, wherein:
the plurality of grooves is formed as a plane parallel to a central axis of the first metal portion.

9. The bus bar of claim 1, wherein:
a bolt fastening hole is formed on a bottom of the first metal portion.

10. A method of manufacturing a bus bar, the method comprising:
processing a first metal portion of a first metal material;
processing a second metal portion of a different material than the first metal material;
plating the second metal portion with silver; and
welding the first metal portion and the second metal portion by a rotation friction welding (RFW).

11. The method of claim 10, wherein the welding includes:
mounting one of the first metal portion and the second metal portion in a clamp chuck;
mounting the other of the first metal portion and the second metal portion in a rotation chuck;
rotating the metal portion mounted in the rotation chuck;
contacting the metal portion mounted in the rotation chuck to the metal portion mounted in the clamp portion;
stopping the rotation chuck; and
pressing the metal portion of the rotation chuck to the metal portion of the clamp chuck.

12. The method of claim 10, further comprising:
removing a burr formed by the rotation friction welding.

13. The method of claim 10, further comprising:
processing a stepped portion in the second metal portion.

14. The method of claim 13, wherein:
the stepped portion is formed by a first body and a second body,
a diameter of the first body is the same as the diameter of the first metal portion, and
a diameter of the second body is smaller than the diameter of the first body.

15. The method of claim 13, further comprising:
processing a plurality of grooves in the second metal portion.

16. The method of claim 15, wherein:
the plurality of grooves is parallel to a central axis of the bus bar.

17. The method of claim 10, further comprising:
processing a bolt fastening hole in a bottom of the first metal body.
